(19) United States
(12) Patent Application Publication
(10) Pub. No.: US 2007/0118528 A1
(43) Pub. Date: May 24, 2007

(54) Apparatus and method for blocking phishing web page access

(76) Inventors: Su Gil Choi, Daejeon-city (KR); Seung Wan Han, Gwangjoo-city (KR); Chi Yoon Jeong, Daejeon-city (KR); Taek Yong Nam, Daejeon-city (KR); Jong Soo Jang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/507,330

(22) Filed: Aug. 21, 2006

(30) Foreign Application Priority Data
Nov. 23, 2005 (KR) 10-2005-0112332

(51) Int. Cl. G06F 17/30

(52) U.S. Cl. 707/9

(57) ABSTRACT

An apparatus and a method for blocking access to a phishing web page are provided. The apparatus includes a media collection unit collecting media having a function of connecting to a web page, a management unit managing phishing information comprising at least one of location information on phishing web pages, location information on web pages targeted for phishing, and features of the phishing web pages, a phishing determination unit determining whether a collected medium is connected to a phishing web page and a phishing blocking unit blocking a link connecting to the phishing web page by editing the medium determined to connect to the phishing web page by the phishing determination unit. According to the present invention, damage caused by phishing can be prevented, even when a web page or an e-mail provided by a web site or an e-mail server includes a link connecting to a phishing web page.

### CROSS-REFERENCE TO RELATED PATENT APPLICATION

This application claims the benefit of Korean Patent Application No. 10-2005-01 12332, filed on Nov. 23, 2005, in the Korean Intellectual Property Office, the disclosure of which is incorporated herein in its entirety by reference.

### BACKGROUND OF THE INVENTION

1. Field of the Invention

The present invention relates to an apparatus and a method for protecting personal information, and more particularly, to an apparatus and a method for blocking phishing web page access.

2. Description of the Related Art

A phishing web page is a fake web page made for illegal obtaining of personal information. The phishing web page approaches a user through a link included in a web page or an e-mail, and the user accesses the phishing web page by clicking the link or a text linked to the link.

A conventional method of blocking phishing web page access is a passive method in which a phishing web page is detected by a government authority based only on reports from internet users, and the corresponding phishing web page is then removed by the government authority. In this case, detection and removal of the phishing web page depends on a report from internet users only. Thus, method is limited of still having the possibility of leaking personal information on many individuals regardless of whether there is a late report or no report about the corresponding phishing web page from internet users. In addition, when the corresponding phishing web page resides in a server located in a foreign country, it is difficult to remove the corresponding phishing web page. In some cases, it may be difficult to remove the phishing web page immediately, although the phishing web page resides in a domestic server. The problems described above occur, since, in the conventional method, even though removing the phishing web page is carried out, a pathway that is a link connecting to the phishing web page is still not blocked.

Since e-mails are commonly used as a medium for accessing phishing web pages, a method of authorizing an email sender has been proposed. However, this method requires changing the total e-mail system so as to provide a function of authorizing an e-mail sender. Accordingly, the method cannot be applied in practice. Moreover, if the authorization of an e-mail sender is applicable, an authorized individual can send an e-mail linked to a phishing web page, so the method could function only as a way to search for a scammer after a leakage of personal information has occurred.

### SUMMARY OF THE INVENTION

The present invention provides an apparatus and a method for blocking access to a phishing web page linked in a web page or an e-mail. According to an aspect of the present invention, there is provided an apparatus for blocking access to a phishing web page, comprising: a media collection unit collecting media having a function of connecting to a web page; a management unit of phishing information managing phishing information comprising at least one of location information on phishing web pages, location information on web pages targeted for phishing, and features of the phishing web pages; a phishing determination unit determining whether a collected medium is connected to a phishing web page based on a match of location information on a web page connected through the collected medium and the location information on the phishing web page or a web page targeted for phishing included in the phishing information or a similarity of a feature of the web page connected through the collected media and a feature included in the phishing information; and a phishing blocking unit blocking access to a link connecting to the phishing web page by editing the medium determined to connect to the phishing web page by the phishing determination unit.

According to another aspect of the present invention, there is provided a method of blocking access to a phishing web page, the method comprising: (a) storing phishing information comprising at least one of location information on phishing web pages, location information on web pages targeted for phishing, and features of phishing web pages; (b) collecting media having a function of connecting to a web page; (c) determining whether a collected medium is connected to a phishing web page based on a match of location information on a web page connected through the collected medium and location information on the phishing web pages or the web pages targeted for phishing included in the phishing information or a similarity of a feature of the web page connected through the collected media and a feature included in the phishing information; (d) blocking access to a link connecting to the phishing web page by editing the medium determined to connect to the phishing web page by the phishing determination unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for blocking access to a phishing web page, according to an embodiment of the present invention;

FIG. 2 is a block diagram of a media collection unit of the apparatus illustrated in FIG. 1, according to an embodiment of the present invention;

FIG. 3 is a block diagram of a management unit of phishing information of the apparatus illustrated in FIG. 1 according to an embodiment of the present invention;

FIG. 4 is a block diagram of a determination unit of a phishing web page of the apparatus illustrated in FIG. 1, according to an embodiment of the present invention;

FIG. 5 is a block diagram of a verification unit of a phishing web page of the apparatus illustrated in FIG. 1, according to an embodiment of the present invention;

FIG. 6 is a block diagram of a phishing blocking unit of the apparatus illustrated in FIG. 1, according to an embodiment of the present invention; and

FIG. 7 is a flowchart of a method of blocking access to a phishing web page, according to an embodiment of the present invention.

### DETAILED DESCRIPTION OF THE INVENTION

Hereinafter, the present invention will be described in detail by explaining embodiments of the invention with reference to the attached drawings. In an apparatus and a method for blocking access to a phishing web page according to an embodiment of the present invention, it is determined whether a web page linked from a web page of a web site or an email stored in an e-mail server is a phishing web page, a Uniform Resource Locator (URL) list of phishing web pages is generated, and a link is removed from the web page or the e-mail connecting to the phishing web page or the web page or the e-mail is directly removed to block access to the phishing web page. In other words, leakage of personal information can be prevented by detecting the phishing web page using an automated method, and blocking the phishing web page immediately.

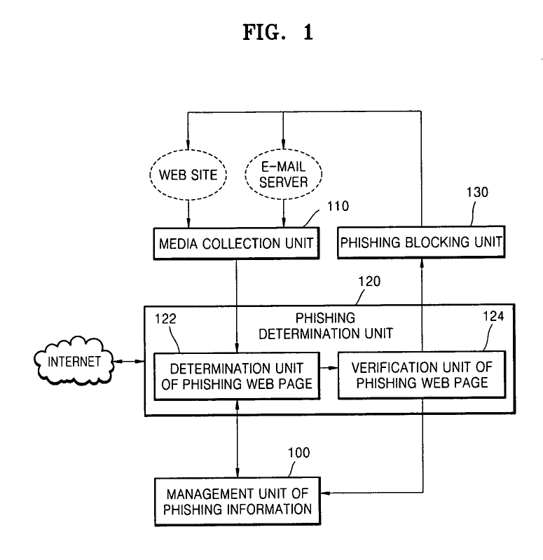

FIG. 1 is a block diagram of an apparatus for blocking access to a phishing web page, according to an embodiment of the present invention.

The apparatus includes a management unit 100 for managing phishing information, a media collection unit 110, a phishing determination unit 120, and a phishing blocking unit 130.

The management unit 100 stores and manages phishing information which is basic information required to detect a phishing web page. Examples of phishing information are location information on phishing web pages, location information on web pages targeted for phishing, features of the phishing web pages, names of web pages targeted for phishing, and features of media enticing users to the phishing web pages. In this embodiment, the location information is information indicating the location of a web page such as a URL and an IP address of the phishing web page. Web pages targeted for phishing include potential targets for phishing, along with enterprises targeted for phishing in the past. Examples of web pages targeted for phishing are names of companies, enterprises, and institutions. When there is phishing information that has been obtained in advance such as known phishing web pages and URLs, the phishing information on known phishing web pages and URLs may be stored in the management unit 100 and a URL of the phishing web page obtained according to an embodiment of the present invention may be stored additionally in the management unit 100 as a part of the phishing information.

The media collection unit 110 collects media having a function of connecting to a web page. Examples of media are web pages and e-mails. In other words, a user is connected to a phishing web page by clicking on a corresponding portion of a linked web page or a linked e-mail. In other words, the media collection unit 110 collects web pages or e-mails automatically from web sites or e-mail servers, extracts information required to detect a phishing web page, and transfers the extracted information to the phishing determination unit 120. In this embodiment, examples of information required to detect a phishing web page are links in the collected web pages or e-mails, links connecting to the URLs, and features of the collected web pages or e-mails.

The phishing determination unit 120 determines whether a collected web page or e-mail is connected to a phishing web page based on the information received from the media collection unit 110 and the phishing information received from the management unit 100. When the collected web page or e-mail is determined to be connected to a phishing web page, the phishing determination unit 120 provides information on the web page or e-mail to the phishing blocking unit 130 and to the management unit 100.

An example of a method of determining whether a web page or an e-mail is connected to a phishing web page will be described below.

First, based on a match of location information on a web page connected to the phishing web page through the collected media and the location information included in the phishing information, it is determined whether the collected media is connected to the phishing web page. In other words, when a URL that is connected through the collected web page or e-mail is a URL of a phishing web page included in the phishing information, the collected media is determined to be connected to the phishing web page.

Second, whether the collected medium is connected to a phishing web page is determined by determining whether the location information marked in the collected media and an address connected by the marked positional information are connected to the same IP address. In other words, whether a URL included in the text of the collected medium and a URL connected by the text are connected to the same IP address is compared to determine whether the collected medium is connected to a phishing web page. If the URL included in the text of the collected medium and the URL connected by the text are connected to the same IP address, it is assumed that there is a low possibility of connecting to the phishing web page.

Third, when in the collected medium, a name of a web page targeted for phishing included in the phishing information is indicated, whether the location information on a web page which is connected by the indicated name is the same as the location information on a web page targeted for phishing included is determined to determine whether the collected medium is connected to a phishing web page. In other words, when there is name of a web page targeted for phishing in the text of the collected medium and the URL connected by the text is connected to an IP address of the web page targeted for phishing, it is assumed that the possibility of connecting to a phishing web page is low.

Fourth, whether a feature of the collected medium is a feature of a medium enticing users to phishing web pages included in the phishing information is determined to determine whether the collected medium is connected to the phishing web page. An example of a feature of the medium enticing users to phishing web pages is the phrase, “Click here to update your account“. When this phrase is included, it can be assumed that there is a high possibility of connecting to a phishing web page.

Fifth, based on a similarity of features of the web page connected through the collected medium and the web page targeted for phishing included in the phishing information or the phishing web page included in the phishing information, whether the collected medium is connected to the phishing web page is determined. In other words, when features of the web page connected through the collected medium and the phishing web page are similar, there is a high possibility of connecting to the phishing web page. On the other hand, when the features of the web page connected through the collected medium and the web page targeted for phishing are similar, there is a low possibility of connecting to the phishing web page. As a determination method of the similarity, a similarity between images included in the feature of the web page connected through the collected medium and included in the phishing information may be determined based on at least one of size, location, name, and format of a file. However, the methods described above are embodiments only, so the method of determining whether the collected web page or e-mail has a link connecting to the phishing web page is not limited thereto.

In addition, the phishing determination unit 120 may include a determination unit 122 for determining a phishing web page, and a verification unit 124 for verifying a phishing web page as illustrated in FIG. 1, so that verification of a phishing web page by an expert is possible.

The phishing determination unit 120 detects a web page having a high possibility of being a phishing web page by analyzing information received from the media collection unit 110 and transferring the detected information to the verification unit 122 and the phishing blocking unit 130. In addition, the phishing determination unit 120 may include the determination unit 122 and the verification unit 124 as illustrated in FIG. 1 to verify the presence of the phishing web page. Here, the determination unit 122 transfers the result from performing the determination function, that is information on a web page determined to have a high possibility of being the phishing page and the information on the collected web page or e-mail to the verification unit 124.

In the verification unit 124, each of a plurality of web pages determined to have a high possibility of being phishing web page by the phishing determination unit 120 are checked by an expert to verify conclusively whether the web page is a phishing web page and provides to the phishing blocking unit 130 information on web pages or e-mails that have been finally determined to be connected to phishing web pages. Thereafter, the management unit 100 updates the current phishing information by adding a portion corresponding to the phishing information included in the received information on the web page or e-mail. The phishing blocking unit 130 connects to a web site or an e-mail server based on the received information on the web page or e-mail and edits the web page or the e-mail by removing the link connecting to the phishing web page in the web page or e-mail.

The phishing blocking unit 130 edits a medium determined to be connected to the phishing web page by the phishing determination unit 120 for blocking access to a link connected to the phishing web page. In other words, the phishing blocking unit 130 receives from the phishing determination unit 120 a URL of the phishing web page and information on the web page or e-mail having a link to the phishing web page, edits the web page or the e-mail connecting to the phishing web page to block access to the link which is connected to the phishing web page.

An example of an editing method is removing a related link or text for preventing connection to the phishing web page, or removing the whole web page or e-mail.

The management unit 100 adds phishing information extracted from the web page or e-mail determined to be connected to the phishing web page to the current phishing information for an update. In other words, the management unit 100 adds a URL of the phishing web page, a target for phishing, and the sort included in the web page or e-mail that was determined to be connected to the phishing web page by the phishing determination unit 120 to the current phishing information for an update.

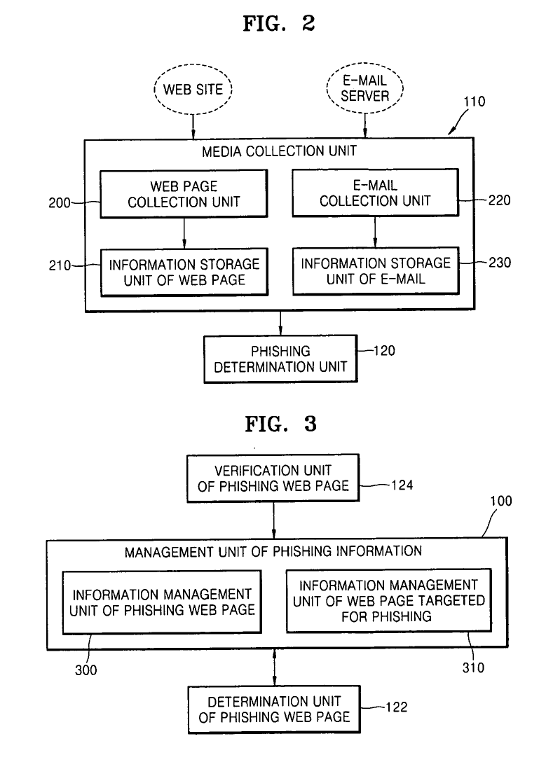

FIG. 2 is a block diagram of the media collection unit 110 in FIG. 1 according to an embodiment of the present invention. The media collection unit 110 includes a web page collection unit 200, a storage unit 210 of web page information, an e-mail collection unit 220, and a storage unit 230 of e-mail information.

The web page collection unit 200 collects web pages in a web site automatically. Examples of collection methods are collecting all the web pages of a plurality of web sites like a web robot for a search engine and collecting web pages satisfying a predetermined condition in predetermined web sites. When a change in the web page is not checked frequently, damage can be caused by a phishing web page, since the phishing web page exists for a short period. Accordingly, the latter method may have an advantage over the former method of collecting all the web pages of the plurality of web sites. In other words, a web page collecting apparatus for each web site should be prepared and changes in web sites should be checked frequently enough. The latter method may be implemented by having a general-purpose web robot such as a web robot for a search engine to collect web pages in predetermined sites. If a function of selecting web pages for collection such as a collection of dynamically generated web pages or web pages generated during a period is included, the collection of web pages or e-mails required to detect a phishing web page can be performed efficiently. If only dynamic or recently generated web pages are collected and tested, the time required to detect a phishing web page can be decreased by decreasing the time required for collection and analysis.

The storage unit 210 of web page information stores a URL, content of the collected web page, link information included in the web page that is a linked text and a URL connected through the text, and transfers the stored information to the phishing determination unit 120. Although the general-purpose web robot extracts only a linked URL when extracting link information included in the web page, the link information is stored in the storage unit 210 of web page information as a form of a set of linked texts and linked URLs, since a linked text plays an important role in the analysis of the phishing web page. For example, if a text in a web page, “http://signin.ebay.com”, has a link of “http://cgi3.ebay.com.wws2.us”, the link information is stored in the form of “http://signin.ebay.com, http://cgi3.ebay.com.wws2.us”. On the other hand, all contents of the web page may be transferred to the phishing determination unit 120, and a feature used to determine similarities between web pages may be extracted and transferred.

The e-mail collection unit 220 collects e-mails in e-mail servers automatically. According to an embodiment of the present invention, the e-mail collection unit 220 can be implemented as an apparatus retrieving e-mails from a file or a database according to information in a list of e-mails, since the e-mail server stores e-mails in a file or database and maintains the list of e-mails. When all the e-mails in the e-mail servers are collected, there is a possibility of infringement on personal privacy, so only e-mails that e-mail holders agreed to collecting may be collected, or only recent e-mails during a predetermined period may be collected.

The storage unit 230 stores information on an identifier, content of a collected e-mail and a link included in the e-mail, and transfers the information to the phishing determination unit 120. In this embodiment, the link information is stored in the same form as in the storage unit 210.

FIG. 3 is a block diagram of the management unit 100 illustrated in FIG. 1 according to an embodiment of the present invention. The management unit 100 includes an information management unit 300 and an information management unit 310 of a web page targeted for phishing.

The information management unit 300 stores and manages URLs of phishing web pages, contents of web pages and names of companies, institutions, or organizations targeted for phishing. In this embodiment, the names of companies, institutions, or organizations targeted for phishing are names of companies, institutions, or organizations which have been passed off for obtaining personal private information. The phishing web page information is input by a supervisor in an initial stage of the apparatus, and the phishing web page information obtained during an operation of the apparatus is input to the information management unit 300. Alternatively, a feature required to determine a similarity between web pages may be stored only, instead of storing all the contents of the web page.

The information management unit 310 of the web page targeted for phishing stores and manages URLs of web pages, contents of the web pages, company names, and related URLs of the phishing web pages as information on web pages potentially targeted for phishing. A web page targeted for phishing is a web for which another web page passes itself off as the web page. The web pages potentially targeted for phishing are web pages that occur when there is an emergence of another web page passing off as the web page is expected. For example, even though phishing web pages targeting some banks and online shopping malls have not been found yet, there is a high possibility of emergence of web pages passing themselves off as the web pages, so the banks and online shopping malls are treated as web pages potentially targeted for phishing. The information on the web pages targeted or potentially targeted for phishing is input by the supervisor in an initial stage of operation of the apparatus and information on the web pages targeted or potentially targeted for phishing obtained during the operation of the apparatus is input to the information management unit 310.

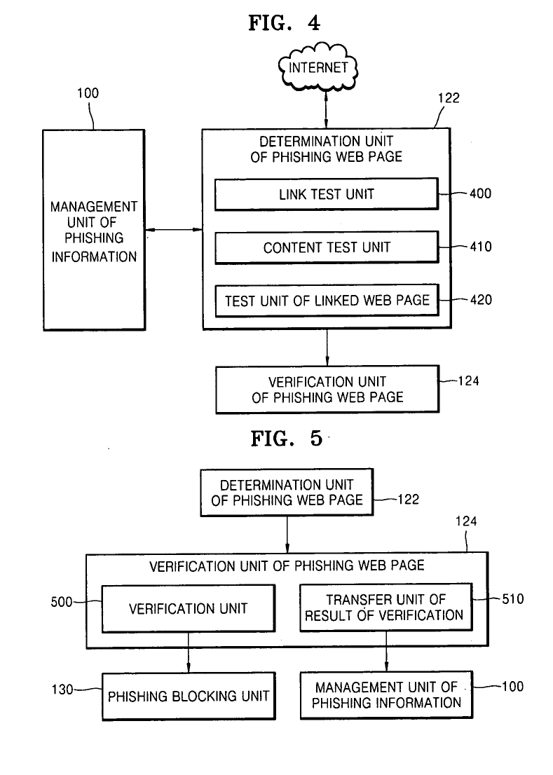

FIG. 4 is a block diagram of the determination unit 122 illustrated in FIG. 1 according to an embodiment of the present invention. The determination unit 122 includes a link test unit 400, a content test unit 410, and a test unit 420 for a linked web page. For the detection of the phishing web page, the three test methods described above may be employed selectively.

The link test unit 400 checks whether a URL linked from the collected web page or e-mail is a known URL of a phishing web page and detects the web page or e-mail having a link connected to the phishing web page. The known URL of the known phishing web page can be obtained from the management unit 100. When the URL of the web page or email is not a known URL of a known phishing web page, the linked text and an actually linked URL are tested together to calculate a possibility of linking to the phishing web page. When the linked text is a URL or includes a URL, it is checked whether a URL included in the linked text as a visual link and the actually linked URL as an actual link are linked to the same IP address. When the IP address connected by the two URLs is not the same, there is a high possibility of a link connecting to the phishing web page. Since there is a possibility of misjudging when comparing the two linked URLs, a test for checking whether the URLs are connected to the same IP address should be performed. When the linked text does not include a URL, it is checked whether the name of company/association/institution targeted or potentially targeted for phishing is included in the linked text, and if there is a name of the company/association/institution in the linked text, whether the linked URL is connected to an IP address of a web site corresponding to the name is checked. When the linked URL is connected to a different IP address, there is a high possibility of a link connecting to the phishing web page. Finally, whether there is a frequently used phrase for phishing in the linked text is checked to calculate the possibility of a link connecting to the phishing web page. For example, when a text such as “click here to update your accounting” has a link, there is a possibility that the link is connected to the phishing web page.

The content test unit 410 tests whether characteristics appearing in the web page or e-mail enticing users to a phishing web page are included by analyzing contents of the collected web page or e-mail. After web pages and e-mails for enticing users to a phishing web page are collected and features are extracted from the web pages and e-mails, respectively, and through a machine learning process, a learning model which presents characteristics of web pages enticing users to a phishing web page and a learning model which presents characteristics of an e-mail enticing users to a phishing web page are generated. The feature is extracted from the collected web page or e-mail and a similarity between the extracted feature and the learning model is calculated to calculate the possibility that the web page or the e-mail is for enticing users to a phishing web page.

The test unit 420 compares the linked web page to known phishing web pages and web pages targeted or potentially targeted for phishing and calculates the possibility that the linked web page is a phishing web page. The information on the web pages targeted or potentially targeted for phishing can be obtained from the management unit 100. The test of the linked web page includes two kinds of methods. The first method includes checking a similarity between distinctive images in the web pages, and the second method is a method checking an overall similarity between the web pages using an algorithm calculating a similarity between web pages. The two kinds of methods can be applied selectively. In the first method, distinctive images are extracted from the linked web page, and a similarity of the extracted and distinctive images in known phishing web pages or web pages targeted or potentially targeted for phishing is analyzed to calculate a possibility that the linked web page is a phishing web page. A size, a location in a web page, a name, and a file format of the image may be compared. In the second method, an overall similarity between the web pages along with the similarity between the images is compared. An algorithm for checking the similarity between web pages used in a search engine such as Google to remove similar search results may be used. A similarity between the linked web page and known phishing web pages or targeted or web pages potentially targeted for phishing is analyzed to calculate the possibility that the linked web page is a phishing web page.

FIG. 5 is a block diagram of the verification unit 124 illustrated in FIG. 1, according to an embodiment of the present invention. The verification unit 124 includes a verification unit 500 and a transfer unit 510.

In the verification unit 500, a web page determined to be a phishing web page by the link test unit 400, the contents test unit 410, and linked web page test unit 420, is checked by an analysis expert to finally verify whether the linked web page is a phishing web page. The transfer unit 510 transfers a URL of the web page, contents of the web page, a name of the company, association, or institution targeted for phishing as information on the finally determined phishing web page, a name of the company, association, or institution, and a URL of a related phishing web page as information on a web page targeted web page of phishing to the management unit 100 and transfers the URL of the phishing web page, and information on the web page or e-mail including a link in the page to the phishing blocking unit 130.

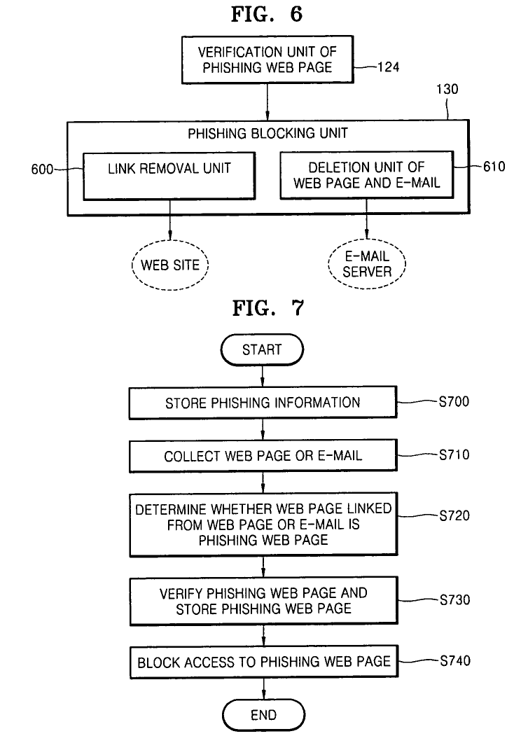

FIG. 6 is a block diagram of the phishing blocking unit 130 illustrated in FIG. 1 according to an embodiment of the present invention. The phishing blocking unit 130 includes a link removal unit 600 and a deletion unit 610 for deleting a web page and an e-mail. Two methods can be applied selectively to block access to a phishing web page. The URL of the phishing web page and information on the web page or e-mail including a link to the phishing page is received by the phishing blocking unit 130.

The link deletion unit 600 receives the URL of the phishing web page and information on the collected web page or e-mail, connects to a corresponding web site or an e-mail server, and removes a link connecting to the web page or the e-mail and the URL of the phishing web page to block access to the actual phishing web page even though users access a web page or an e-mail enticing users to the phishing.

The deletion unit 610 receives information on the collected web page or e-mail, connects to a corresponding web site or e-mail server, and deletes the web page or e-mail. In other words, the users are prevented from viewing the web page or e-mail enticing users to phishing.

FIG. 7 is a flowchart of a method of blocking access to a phishing web page, according to an embodiment of the present invention.

Information on known phishing web pages and targeted or potentially targeted web pages are stored in the storage unit 100 as phishing information (S700). In other words, the phishing information including at least one of location information of phishing web page, web pages targeted for phishing, and a feature of the phishing web page is stored. Thereafter, web pages in predetermined web sites or e-mails in predetermined e-mail servers are automatically collected by the media collection unit 110, and information required to check the phishing web page is extracted and stored (S710). Whether a link in the collected web page or e-mail is connected to the phishing web page is determined by the phishing determination unit 120 based on the collected information and the phishing information, and a result is provided to the phishing blocking unit 130 and the management unit 100. In other words, collected information is analyzed by the determination unit 122 and a web page having a high possibility of being a phishing web page is detected (S720). The web page determined to have high possibility of being a phishing web page is verified by the verification unit 124, and the information on the phishing web page is stored (S730). The web page or e-mail is edited by the phishing blocking unit 130 which has received information on the web page or e-mail having a link to the phishing web page, and as a result, the access to the URL of the phishing web page is blocked (S740). Otherwise, the phishing information extracted from the web page or e-mail determined to be connecting to the phishing web page is provided to the management unit 100, so the current phishing information is updated.

The present invention may be applied in a tool in which whether a web page in a predetermined web site or a web page linked from an e-mail stored in an e-mail server is a phishing web page is determined, a URL list of the phishing web pages is generated, and the link on the web page or e-mail to the phishing web page is removed to block access to the phishing web page. In other words, when installed into a web server or an e-mail server, a web page included in a web site or an e-mail stored in an e-mail server is prevented from being used as a connection path to a phishing web page.

A phishing web page database such as a URL list of the phishing web pages obtained using the processes described above can be used for Internet access control software installed in a personal computer to block internet users' access to a phishing web page.

A conventional method of blocking access to a phishing web page is a passive method in which the government removes a checked phishing web page according to reports from internet users. Thus, in the conventional art, the phishing web page is blocked after many victims have emerged. However, according to the present invention, a particular individual web server or an e-mail server detects a phishing web page actively, and blocks the phishing web page instantly, so that damage caused by a leakage of personal information can be prevented in advance.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for blocking access to a phishing web page, comprising:
a media collection unit collecting media having a function of connecting to a web page;
a management unit of phishing information managing phishing information comprising at least one of location information on phishing web pages, location information on web pages targeted for phishing, and features of the phishing web pages;
a phishing determination unit determining whether a collected medium is connected to a phishing web page based on a match of location information on a web page connected through the collected medium and the location information on the phishing web page or a web page targeted for phishing included in the phishing information or a similarity of a feature of the web page connected through the collected media and a feature included in the phishing information; and
a phishing blocking unit blocking access to a link connecting to the phishing web page by editing the medium determined to connect to the phishing web page by the phishing determination unit.

2. The apparatus of claim 1, wherein the phishing determination unit determines whether the collected medium is connected to the phishing web page by determining whether an actual IP address of location information indicated in the collected medium and an IP address connected according to the location information indicated in the collected medium are the same.

3. The apparatus of claim 1, wherein
the phishing information comprises names of web pages targeted for phishing, and
the phishing determination unit determines whether the collected medium is connected to a phishing web page by determining whether location information on a web page to be connected according to the indicated name is the same as the location information on the web page targeted for phishing included in the phishing information, when names targeted for phishing included in the phishing information are indicated in the collected medium.

4. The apparatus of claim 1, wherein
the phishing information comprises features of media enticing users to a phishing web page, and
the phishing determination unit determines whether the collected medium is connected to a phishing web page by determining whether the feature of the collected media is the same as the feature of a medium enticing users to phishing included in the phishing information.

5. The apparatus of claim 1, wherein
the phishing information comprises features of web pages targeted for phishing, and
the phishing determination unit determines whether the collected medium is connected to a phishing web page based on a similarity between the feature of the connected web page through the collected media and the web pages targeted for phishing included in the phishing information.

6. The apparatus of claim 1 or 5, wherein the determination of the similarity in the phishing determination unit is determined by the similarities between images included in a feature of the web page connected through the collected medium and included in features included in the phishing information based on at least one of size, location, name, and file format.

7. The apparatus of claim 1, wherein the media collection unit collects only e-mails that e-mail holders have agreed to are collected.

8. The apparatus of claim 1, wherein the phishing blocking unit removes a phrase or a link connecting to a phishing web page from the medium determined to be connected to the phishing web page or the determined medium.

9. The apparatus of claim 1, wherein the phishing information management unit adds to the phishing information new phishing information extracted from the web page or e-mail determined to be connected to the phishing web page for an update.

10. A method of blocking access to a phishing web page, the method comprising:
(a) storing phishing information comprising at least one of location information on phishing web pages, location information on web pages targeted for phishing, and features of phishing web pages;
(b) collecting media having a function of connecting to a web page;
(c) determining whether a collected medium is connected to a phishing web page based on a match of location information on a web page connected through the collected medium and location information on the phishing web pages or the web pages targeted for phishing included in the phishing information or a similarity of a feature of the web page connected through the collected media and a feature included in the phishing information;
(d) blocking access to a link connecting to the phishing web page by editing the medium determined to connect to the phishing web page by the phishing determination unit.

11. The method of claim 10, wherein (c) comprises determining whether the collected medium is connected to the phishing web page by determining whether an actual IP address of location information indicated in the medium is the same as an IP address connected according to the location information indicated in the medium.

12. The method of claim 10, wherein
the phishing information comprises names targeted for phishing, and
(c) determines whether the collected medium is connected to a phishing web page by determining whether location information on a web page to be connected according to the indicated name is the same as the location information on the web pages targeted for phishing included in the phishing information, when names targeted for phishing included in the phishing information are indicated in the collected medium.

13. The method of claim 10, wherein
the phishing information comprises features of the collected media enticing users to a phishing web page, and
wherein the (c) comprises determining whether the collected medium is connected to a phishing web page by determining whether the feature of the collected media is the same as a feature of a medium enticing users to phishing included in the phishing information.

14. The method of claim 10, wherein
the phishing information comprises features of web pages targeted for phishing, and
(c) determines whether the collected medium is connected to a phishing web page based on a similarity between a feature of the connected web page through the collected media and the web pages targeted for phishing included in the phishing information.

15. The method of claim 10 or 14, wherein the similarity is determined by determining similarities between images included in a feature of the web page connected through the collected medium and included in features included in the phishing information based on at least one of size, location, name, and file format.

16. The method of claim 10, wherein (b) only e-mails that e-mail holders have agreed to are collected.

17. The method of claim 10, wherein (d) comprises removing a phrase or a link connecting to a phishing web page from the medium determined to be connected to the phishing web page or determined medium.

18. The method of claim 10, further comprising adding to the phishing information new phishing information extracted from the web page or e-mail determined to be connected to the phishing web page for an update.

19. A computer readable medium having embodied thereon a computer program for the method of claim 10.
